(19) United States
(12) Patent Application Publication
(10) Pub. No.: US 2026/0027902 A1
(43) Pub. Date: Jan. 29, 2026

(54) VEHICLE INFORMATION OUTPUT DEVICE, INFORMATION-TO-BE-PROTECTED OUTPUT DEVICE, AND VEHICLE INFORMATION OUTPUT METHOD

(71) Applicant: JVCKENWOOD Corporation, Yokohama-shi (JP)

(72) Inventor: Yuichi Machida, Yokohama-shi (JP)

(21) Appl. No.: 19/348,833

(22) Filed: Oct. 3, 2025

Related U.S. Application Data
(63) Continuation of application No. PCT/JP2024/013894, filed on Apr. 4, 2024.

(30) Foreign Application Priority Data
Apr. 6, 2023 (JP) 2023-061945
Mar. 27, 2024 (JP) 2024-051079
Mar. 27, 2024 (JP) 2024-051080
Mar. 27, 2024 (JP) 2024-051081
Mar. 27, 2024 (JP) 2024-051082
Mar. 27, 2024 (JP) 2024-051083

(51) Int. Cl. B60K 35/29; G06F 21/62; G06F 21/84

(52) U.S. Cl. CPC B60K 35/29; G06F 21/6245; G06F 21/84

(57) ABSTRACT

A vehicle information output device 10 includes: a vehicle information acquisition unit 11 that acquires vehicle information on a vehicle; a data generator 12 that generates data containing the vehicle information; a protection mode selector 14 that selects a protection mode including whether or not protection of the data is necessary based on first information on the vehicle; a data processor 15 that processes the data in the protection mode; and an output unit 16 that outputs the data that has been processed to a storage 40 or an external device via a communicator.

### CROSS-REFERENCE TO RELATED APPLICATIONS

This application is a Continuation of PCT International Application No. PCT/JP2024/013894 filed on Apr. 4, 2024, which claims the benefit of priority from Japanese Patent Application No. 2023-061945, filed on Apr. 6, 2023 and Japanese Patent Applications No. 2024-051079, No. 2024-051080, No. 2024-051081, No. 2024-051082 and No. 2024-051083 filed on Mar. 27, 2024, the entire contents of all of which are incorporated herein by reference.

### BACKGROUND OF THE INVENTION

### 1. Field of the Invention

The present invention relates to a vehicle information output device, an information-to-be-protected output device, and a vehicle information output method.

### 2. Description of the Related Art

There is known a technique of encrypting or abstracting data capable of identifying a person as conversion needed data (e.g., see JP 2021-43571 A). The data capable of identifying a person includes image data containing a face and a body among pieces of information obtained by observing an occupant.

Personal information concealed by the technique described in JP 2021-43571 A includes a face image and iris information of an occupant, capable of identifying a person, an image of, for example, a license plate of the vehicle, and an address printed on a sign. Privacy is, however, not limited to those judged based on whether or not a person can be identified. Appropriately protecting information is required to achieve both protection of the privacy of an occupant of a vehicle and management of travel information on the vehicle.

The present disclosure has been made in view of the above, and provides a vehicle information output device and a vehicle information output method capable of achieving both appropriate protection of the privacy of an occupant of a vehicle and appropriate management of travel information on travel of the vehicle by selecting a data protection mode for recording travel information on the vehicle based on first information on the vehicle. Note that an object of the present disclosure is not limited to solving the above-described problem. A problem to be solved is set for each embodiment or variation to be described later. The present disclosure includes disclosing a solution for solving the problem.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

A vehicle information output device according to the present disclosure comprising: a vehicle information acquisition unit that acquires vehicle information on a vehicle; a data generator that generates data containing the vehicle information; a protection mode selector that selects a protection mode including whether or not protection of the data is necessary based on first information on the vehicle; a data processor that processes the data in the protection mode; and an output unit that outputs the data that has been processed to a storage or an external device via a communicator.

An information-to-be-protected output device according to the present disclosure comprising: an information acquisition unit that acquires information to be protected; a data generator that generates data containing the information to be protected; a protection mode selector that selects a protection mode including whether or not protection of the data is necessary based on first information; a data processor that processes the data in the protection mode; and an output unit that outputs the data that has been processed to a storage or an external device via a communicator.

A vehicle information output method according to the present disclosure comprising: executing, by a computer: a vehicle information acquisition step of acquiring vehicle information on a vehicle; a data generation step of generating data containing the vehicle information; a protection mode selection step of selecting a data protection mode based on first information on the vehicle; a data protection step of protecting the data in the protection mode; and an output step of outputting the data that has been protected to a storage or an external device via a communicator.

### BRIEF DESCRIPTION OF THE DRAWINGS

FIG. 1 is a block diagram illustrating an example of a configuration of a vehicle information output system according to a first embodiment;

FIG. 2 is a flowchart illustrating an example of a processing procedure of a vehicle information output method according to the first embodiment;

FIG. 3 is a block diagram illustrating an example of a configuration of a vehicle information output system according to a second embodiment;

FIG. 4 is a flowchart illustrating an example of a processing procedure of a vehicle information output method according to the second embodiment;

FIG. 5 is a block diagram illustrating an example of a configuration of a vehicle information output system according to a third embodiment;

FIG. 6 is a flowchart illustrating an example of a processing procedure of a vehicle information output method according to the third embodiment;

FIG. 7 is a block diagram illustrating an example of a configuration of a vehicle information output system according to a fourth embodiment;

FIG. 8 is a flowchart illustrating an example of a processing procedure of a vehicle information output method according to the fourth embodiment;

FIG. 9 is a block diagram illustrating an example of a configuration of a vehicle information output system according to a fifth embodiment;

FIG. 10 is a flowchart illustrating an example of a processing procedure of a vehicle information output method according to the fifth embodiment;

FIG. 11 is a block diagram illustrating an example of a configuration of a vehicle information output system according to a sixth embodiment;

FIG. 12 is a flowchart illustrating an example of a processing procedure of a vehicle information output method according to the sixth embodiment;

FIG. 13 is a block diagram illustrating an example of a configuration of a vehicle information output system according to a seventh embodiment;

FIG. 14 is a flowchart illustrating an example of a processing procedure of a vehicle information output method according to the seventh embodiment;

FIG. 15 is a block diagram illustrating an example of a configuration of a vehicle information output system according to an eighth embodiment; and

FIG. 16 is a flowchart illustrating an example of a processing procedure of a vehicle information output method according to the eighth embodiment.

### DETAILED DESCRIPTION OF THE PREFERRED EMBODIMENTS

Although the present disclosure will be described below through embodiments of the invention, the invention according to the claims is not limited to the following embodiments. Furthermore, not all the configurations described in the embodiments are essential as means for solving the problems. For clarity of description, the following description and drawings are appropriately omitted and simplified.

### First Embodiment

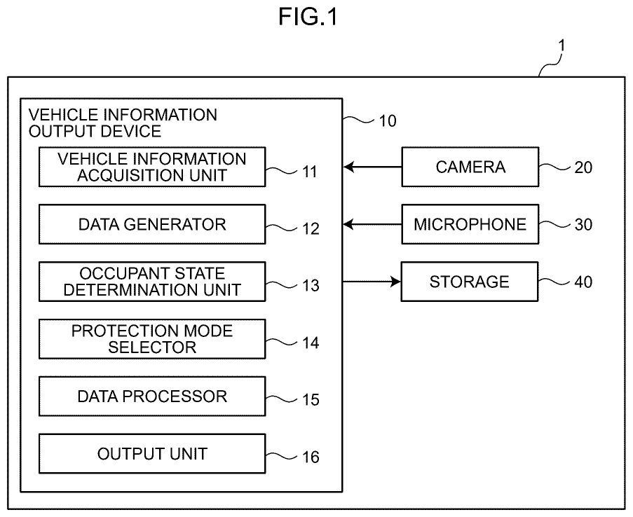

A first embodiment of the present disclosure will be described with reference to FIG. 1. FIG. 1 is a block diagram illustrating an example of a configuration of a vehicle information output system 1 according to the first embodiment. In the first embodiment, information on a state of an occupant of a vehicle is used as first information on the vehicle. An occupant state determination unit 13 to be described later determines the state of the occupant of the vehicle.

The vehicle information output system 1 includes a vehicle information output device 10, a camera 20, a microphone 30, and a storage 40.

The camera 20 is disposed inside the vehicle or outside the vehicle. The camera 20 captures an image around the vehicle and an image of a range including the inside of the vehicle, for example, the occupant of the vehicle. In the case, the image may be either a still image or a moving image. The camera 20 may be one camera, or may be configured as a group of a plurality of cameras. Furthermore, the camera 20 may be a mobile device owned by the occupant of the vehicle.

The microphone 30 is disposed inside the vehicle, outside the vehicle, or around the vehicle. The microphone 30 collects sound around the vehicle, sound inside the vehicle, or a voice uttered by the occupant of the vehicle. The microphone 30 may be one microphone, or may be configured as a group of a plurality of microphones. Furthermore, the microphone 30 may be a mobile device owned by the occupant of the vehicle.

The storage 40 records vehicle information on the vehicle. In an example, the storage 40 is a storage device such as a storage medium, a nonvolatile memory, a hard disk drive, and a solid state drive (SSD). The storage medium includes a memory card provided in the vehicle. The nonvolatile memory includes a flash memory. The storage 40 may be integrated with the vehicle information output device 10, or may be a device separated from the vehicle information output device 10. The storage 40 stores data output by an output unit 16 to be described later. The data may be a file as an example of a management unit or a storage unit. Such data will be described simply as “data” below. The storage 40 may be provided in an external device connected by communication with the vehicle information output device 10.

The vehicle information output device 10 includes a vehicle information acquisition unit 11, a data generator 12, the occupant state determination unit 13, a protection mode selector 14, a data processor 15, and the output unit 16. The vehicle information output device 10 is provided typically in a business-purpose vehicle. The vehicle information output device 10 achieves both protection of the privacy of an occupant of the vehicle and appropriate management of travel information on travel of the vehicle at business. For example, it is assumed that an occupant of a business-purpose vehicle such as a truck which travels a long distance takes actions such as taking a nap, changing his/her clothes, and making a private call with an outside person inside the vehicle. The vehicle information output device 10 determines such a case as a state in which privacy should be respected, and can output vehicle information in a mode in which the privacy of the occupant of the vehicle is appropriately protected. When the vehicle is traveling at business and when the vehicle is in a state related to business even if the vehicle is stopped, the vehicle information output device 10 can output vehicle information in a mode in which an administrator of the vehicle or the business can easily browse the vehicle information and appropriately manage information on the business. The vehicle information output device 10 may be provided in a general-purpose vehicle, and appropriately protect the privacy of each of occupants of the vehicle.

The vehicle information acquisition unit 11 acquires vehicle information on the vehicle. For example, the vehicle information acquisition unit 11 acquires, from the camera 20, an image obtained by imaging the surroundings of the vehicle or the inside of the vehicle. In addition, the vehicle information acquisition unit 11 may acquire, from the microphone 30, voice collected around the vehicle or inside the vehicle. The vehicle information acquisition unit 11 may acquire information on the current position of the vehicle, which has been calculated based on a received global navigation satellite system (GNSS) signal, from a current position information acquisition unit (not illustrated). The vehicle information acquisition unit 11 may acquire information on the vehicle such as information on acceleration of the vehicle detected by an acceleration sensor (not illustrated). The vehicle information acquisition unit 11 may acquire information on travel of the vehicle from other sensors. The vehicle information acquisition unit 11 may acquire, from the vehicle via a controller area network (CAN), information on the vehicle such as information on whether the vehicle is traveling or stopped, whether or not the engine of the vehicle is stopped, whether or not the parking brake is set, the speed of the vehicle, the opening or closing or lock state of a vehicle door, and the control states of a driving assistance device and an automatic driving device of the vehicle.

The vehicle information acquisition unit 11 outputs the acquired vehicle information on the vehicle to the data generator 12. Furthermore, the vehicle information acquisition unit 11 may output the acquired vehicle information on the vehicle to the occupant state determination unit 13.

The data generator 12 generates data containing the vehicle information on the vehicle, which has been acquired by the vehicle information acquisition unit 11. For example, the data generator 12 generates the image obtained by imaging the surroundings of the vehicle or the inside of the vehicle, which has been acquired by the vehicle information acquisition unit 11 as predetermined type of image data The image data may contain various types of data such as voice data, position information, and acceleration information. The data generator 12 may include an image compressor (not illustrated) that compresses an image in a predetermined method such as H. 264 advanced video coding (AVC). Data generated by the data generator 12 is not limited to image data. The data generator 12 may generate various types of vehicle information acquired by the vehicle information acquisition unit 11 as data such as voice data.

The data generator 12 outputs the generated data containing the vehicle information to the data processor 15.

The occupant state determination unit 13 determines the state of the occupant of the vehicle, and sets information on the determined state of the occupant of the vehicle as the first information on the vehicle. The occupant state determination unit 13 determines, for example, a state related to whether or not the occupant of the vehicle is in the state in which privacy should be respected. For example, the occupant state determination unit 13 determines the state of the occupant of the vehicle from an image obtained by imaging the inside of the vehicle and voice collected inside the vehicle, which have been acquired by the vehicle information acquisition unit 11. The state of the occupant of the vehicle includes whether the occupant of the vehicle is in a state of being engaged in business, for example, in a state of driving the vehicle and whether the occupant of the vehicle is in a private state outside business, for example, in a state of being on a break or being asleep. The occupant state determination unit 13 preferably includes an image recognizer (not illustrated) and a voice recognizer (not illustrated), which determine the state of the occupant of the vehicle from an image and voice.

The occupant state determination unit 13 may determine that the occupant of the vehicle is driving and that the occupant of the vehicle is in a state not related to travel of the vehicle from information on the travel state of the vehicle, which has been acquired by the vehicle information acquisition unit 11. The state not related to travel of the vehicle may be determined from, for example, the fact that the engine of the vehicle is stopped and the parking brake is set. The occupant state determination unit 13 may determine the state of the occupant of the vehicle by deciding the arousal or the brain activity state of the occupant of the vehicle based on information from a biosensor (not illustrated) worn or used by the occupant of the vehicle and analyzing the fact that the occupant of the vehicle is asleep or the fact that the brain is activated. Note that, although the occupant of the vehicle in the case is typically a driver of the vehicle, the occupant of the vehicle is not limited thereto. The occupant of the vehicle may be a passenger of the vehicle, or may be all occupants on board the vehicle. The state of the occupant of the vehicle, which is determined by the occupant state determination unit 13, may be selected from the state of the driver of the vehicle, the state of any predetermined passenger of the vehicle, the states of all the occupants of the vehicle, an average state of all the occupants of the vehicle, and a state in which the largest number of occupants are in the vehicle.

The occupant state determination unit 13 outputs the determined state of the occupant of the vehicle to the protection mode selector 14.

The occupant state determination unit 13 may determine various states of the occupant of the vehicle not only in the above-described form but by using a known method. The occupant state determination unit 13 may determine the state of the occupant of the vehicle by using a signal indicating whether the occupant of the vehicle or another person is at work or on a break. The occupant of the vehicle or the other person manually inputs the signal with an input unit (not illustrated). The occupant state determination unit 13 may determine the state of the occupant of the vehicle by deciding whether now is in a time zone when the occupant of the vehicle is engaged in business or in a time zone when the occupant of the vehicle is on a break by collating a pre-registered work schedule of the occupant of the vehicle with the current time. The occupant state determination unit 13 preferably determines the state of the occupant of the vehicle by multiply using the above-described various types of information acquired by the vehicle information acquisition unit 11 and information acquired from other sensors, the input unit, and pre-registered information.

The occupant state determination unit 13 may decide, for example, that the occupant of the vehicle is uttering a voice or that the occupant of the vehicle is during a call with an outside person with a communication device by using a known technique of image recognition or voice recognition. The occupant state determination unit 13 may determine a state in which the occupant of the vehicle is having a private conversation and privacy should be prioritized by recognizing a voice uttered by the occupant of the vehicle or acquiring information on a call destination. The occupant state determination unit 13 may decide the degree at which privacy should be emphasized in several stages of levels based on information of the expression, behavior, an uttered voice, and a call destination of the occupant of the vehicle. The occupant state determination unit 13 may take a form of deciding the degree at which privacy should be emphasized based on the arousal of the occupant of the vehicle in a case where the occupant of the vehicle is not engaged in business and is on a break. In the form, the occupant state determination unit 13 sets the degree at which privacy should be emphasized as a “low level” in a case of high arousal. The occupant state determination unit 13 sets the degree at which privacy should be emphasized as a “high level” in a case of low arousal. An arousal state is distinguished from a state in which the occupant of the vehicle just wakes up and a state in which the occupant of the vehicle is dozing. The degree at which privacy of the occupant of the vehicle should be emphasized may be decided based on the presence or absence of an uttered voice or the contents of speech of the occupant of the vehicle.

The protection mode selector 14 selects a protection mode including whether or not protection of data is necessary based on the state of the occupant of the vehicle, which has been determined by the occupant state determination unit 13. For example, when the occupant of the vehicle is in a state in which privacy should be respected such as a state of being on a break, the protection mode selector 14 decides that privacy of the occupant of the vehicle is highly likely to be imaged in an image obtained by imaging the surroundings of the vehicle or the inside of the vehicle and collected voice, which have been acquired by the vehicle information acquisition unit 11, and that protection of the image data and the voice data is necessary. Furthermore, the protection mode selector 14 selects a mode of protecting data. In the mode of protecting data, the protection mode selector 14 appropriately selects a protection key for protecting data, such as an encryption key and a password. The encryption key is used to encrypt data. The password is used to protect data with the password. For example, the protection mode selector 14 encrypts data with the selected encryption key, or restricts access of a third party to data by setting the selected password.

For example, when the occupant of the vehicle is in a state of being on a break, the protection mode selector 14 selects a protection key known by the occupant of the vehicle so as to protect and output data in a mode in which the occupant of the vehicle can decode or access the data and a third party cannot decode or access the data. The protection mode selector 14 selects the mode of protecting data with the protection key. For example, the protection mode selector 14 may select a protection key for protecting data based on the degree at which privacy of the occupant of the vehicle should be emphasized, which has been determined by the occupant state determination unit 13. When the degree at which privacy of the occupant of the vehicle should be emphasized is high, the protection mode selector 14 may select a protection key known only by the occupant of the vehicle. When the degree at which privacy of the occupant of the vehicle should be emphasized is low, the protection mode selector 14 may select a protection key known by a plurality of people including the occupant of the vehicle. The protection mode selector 14 may thereby achieve both strength of protecting data and easiness of browsing data. For example, when the occupant of the vehicle is in a state of being engaged in business, data of an image obtained by imaging the surroundings of the vehicle or the inside of the vehicle, which has been generated by the data generator 12, and collected voice may serve as evidence images of, for example, a traffic accident and a near-miss accident related to vehicle, which is important on business. Since such data containing vehicle information is output in a mode in which an administrator of the vehicle or the business can easily browse the data, the protection mode selector 14 decides that protection of data is unnecessary, and selects a mode in which the data is not protected.

The protection mode selector 14 outputs the selected protection mode including whether or not protection of data is necessary to the data processor 15.

Protecting data here means performing encryption processing. In the encryption processing, data is encrypted by a method such as a common key encryption method and a public key encryption method. Only a person who knows an encryption key, which is a selected protection key, is allowed to decode the data. Data may be protected in a mode in which access to the data is restricted by a password, which is a selected protection key, or in a mode in which mosaic processing and mask processing are performed on an image to prevent the contents of the image from being easily recognized. In this case, it is preferable that passwords for canceling the mosaic processing and the mask processing are set and a password can be selected. Protecting data may mean storing data in a predetermined region or a predetermined storage medium of the storage 40, which can be accessed only by a pre-registered person.

In addition to the above-described form, the protection mode selector 14 may select various protection modes. For example, the protection mode selector 14 may select a data protection mode based on the state of the occupant of the vehicle, which has been determined by the occupant state determination unit 13. The data protection mode includes whether protection is performed by a password, a common key encryption method, or a public key encryption method. The protection mode selector 14 may select a protection mode related to encryption strength, such as an encryption algorithm including the bit number of an encryption method. For example, the protection mode selector 14 may select an encryption method and an encryption algorithm of encrypting data based on the degree at which privacy of the occupant of the vehicle should be emphasized, which has been determined by the occupant state determination unit 13. When the degree at which privacy of the occupant of the vehicle should be emphasized is high, the protection mode selector 14 may reduce the probability of the data being decoded by a third party. The protection mode selector 14 selects whether to protect data more strongly or loosely based on the state of the occupant of the vehicle by selecting a data protection mode as described above. This can achieve both data protection strength and prompt decoding or access to the data.

For example, when the occupant of the vehicle is engaged in business, the protection mode selector 14 may decide that protection of data is necessary, and select a mode of protecting data in a form in which an administrator of business of the vehicle can decode or access the data. In other words, a protection key associated with the administrator of the vehicle or the business may be selected. A protection mode of protecting data with the protection key may be selected.

The data processor 15 processes the data generated by the data generator 12 in a data protection mode selected by the protection mode selector 14. The data processor 15 performs processing of protecting an image obtained by imaging the inside of the vehicle, which has been generated by the data generator 12, with the protection key and the protection mode selected by the protection mode selector 14. For example, when the protection mode selector 14 decides that protection is necessary and selects a common key method encryption using an encryption key known by the occupant of the vehicle as a protection mode, the data processor 15 performs encryption by the common key method using the selected encryption key. For example, when the protection mode selector 14 decides that protection is unnecessary, the data processor 15 performs processing of outputting the data generated by the data generator 12 to the output unit 16 as it is without protection.

The data processor 15 outputs the processed data to the output unit 16.

The data processor 15 preferably includes various encryption processors (not illustrated) and an access restriction unit (not illustrated) that restricts access to data using a password in the common key encryption method and the public key encryption method. The encryption processors can preferably select the bit number (key length) of an encryption key related to encryption strength. The encryption processors can select various algorithms having different key lengths, such as an advanced encryption standard (AES) 128 and an AES 256 as, for example, the common key encryption method.

The output unit 16 outputs the data processed by the data processor 15 to the storage 40 or an external device such as an external server, a monitor, and an image processing device via a communicator (not illustrated). When the storage 40 is provided in the external server connected via the communicator, the output unit 16 may transmit the data to the storage 40 via the communicator.

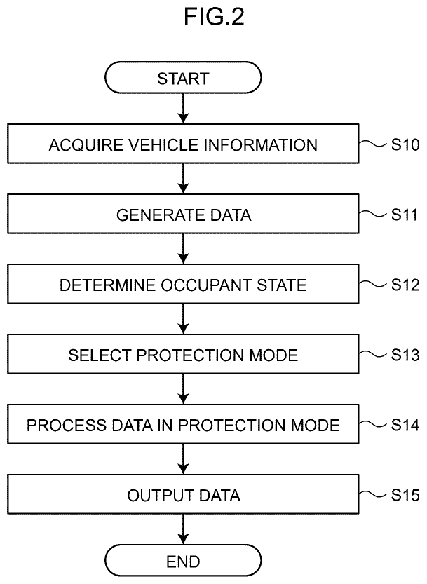

Next, a processing procedure of the vehicle information output device 10 according to the above-described first embodiment will be described with reference to a flowchart of FIG. 2. FIG. 2 is a flowchart illustrating an example of a processing procedure of a vehicle information output method according to the first embodiment.

First, in Step S10, the vehicle information acquisition unit 11 acquires vehicle information on a vehicle, for example, an image captured by the camera 20. The vehicle information acquisition unit 11 outputs the acquired vehicle information on the vehicle to the data generator 12, and proceeds to Step S11.

In Step S11, the data generator 12 generates data containing the vehicle information on the vehicle, which has been acquired by the vehicle information acquisition unit 11, for example, compressed image data. The data generator 12 outputs the generated data containing the vehicle information to the data processor 15, and proceeds to Step S12.

In Step S12, the occupant state determination unit 13 determines the state of the occupant of the vehicle. The occupant state determination unit 13 outputs the determined state of the occupant of the vehicle, for example, a state in which the occupant is on a break, to the protection mode selector 14, and proceeds to Step S13.

In Step S13, the protection mode selector 14 selects a protection mode including whether or not protection of data is necessary based on the state of the occupant of the vehicle. For example, when the occupant of the vehicle is in a state of being on a break, the protection mode selector 14 determines that protection of data is necessary, and selects a protection mode in which data is protected with a selected protection key. The protection mode selector 14 outputs the selected data protection mode to the data processor 15, and proceeds to Step S14.

In Step S14, the data processor 15 processes the data generated by the data generator 12 in the data protection mode selected by the protection mode selector 14. For example, the data processor 15 performs processing of protecting image data with a selected protection key. The data processor 15 outputs the processed data to the output unit 16, and proceeds to Step S15.

In Step S15, the output unit 16 outputs the data processed by the data processor 15 to the storage 40 or an external device via a communicator. The output unit 16 transmits, for example, encrypted image data to a predetermined server via the communicator. Thereafter, the flow ends.

As described above, according to the first embodiment, the vehicle information output device 10 can determine the state of the occupant of the vehicle, select a protection mode of data containing vehicle information based on the state of the occupant, and output data protected in the selected mode.

The vehicle information output device 10 configured as described above enables appropriately protecting and outputting information on the privacy of the occupant of the vehicle in a selected protection mode and outputting travel information on travel of the vehicle in a mode in which the travel information can be appropriately managed to be switched between based on the determined driver state, and can achieve both thereof. For example, an image and voice captured and collected at the time when the occupant of the vehicle takes a break or a nap while being on the vehicle are records of a private time when the privacy of the occupant of the vehicle should be respected even when the image and the voice cannot identify a person. If a third party or an administrator of the vehicle or the business can browse such an image and voice, privacy may be invaded. If such an image and voice are leaked to the outside, a major problem arises. Such an image and voice are thus preferably protected appropriately by a protection key.

### Second Embodiment

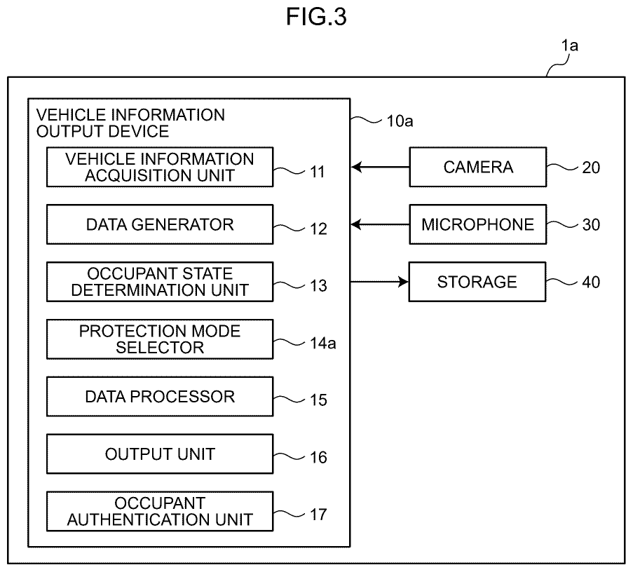

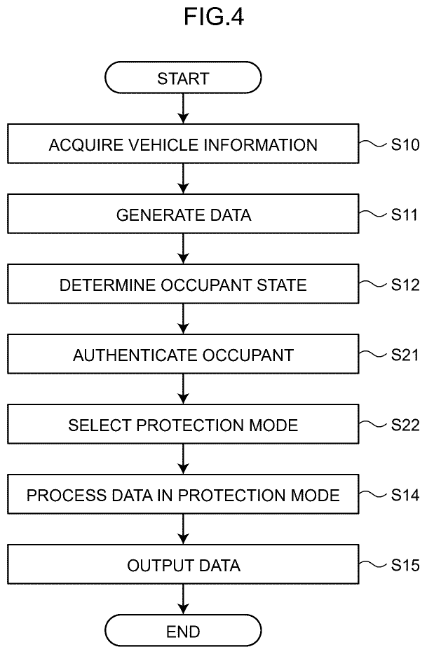

A second embodiment of the present disclosure will be described with reference to FIGS. 3 and 4. FIG. 3 is a block diagram illustrating an example of a configuration of a vehicle information output system 1a according to the second embodiment. The vehicle information output system 1a according to the second embodiment includes a vehicle information output device 10a. The vehicle information output device 10a has a configuration different from that of the vehicle information output device 10 according to the first embodiment in the following point.

That is, an occupant authentication unit 17 and a protection mode selector 14a are provided. Since the vehicle information output device 10a has a configuration and a function similar to those of the vehicle information output device 10 according to the first embodiment except that the vehicle information output device 10a includes the occupant authentication unit 17 and the protection mode selector 14a, detailed descriptions thereof are omitted.

The occupant authentication unit 17 performs personal authentication processing recognizing the occupant of the vehicle as a specific person. The occupant authentication unit 17 authenticates a person by, for example, performing image recognition on the face of the occupant of the vehicle from an image obtained by imaging the inside of the vehicle and deciding whether or not the features of the recognized face of the occupant of the vehicle match a preliminarily stored face image or the features of the face of a person registered in a database (not illustrated) that stores the features of a face. For example, the occupant authentication unit 17 extracts features, such as the relative positions and sizes of parts of a face and the shapes of the eyes, nose, and jaws, from a face image, and calculates the degree of matching between the extracted features and the registered features. The occupant authentication unit 17 thereby judges whether or not the face image of the person matches the face image or the features of a face preliminarily stored in the database.

When a result of authentication of the occupant of the vehicle indicates the registered person, the occupant authentication unit 17 identifies personal information of the matched person, such as his/her name, employee number, and electronic certificate number, from the database.

The occupant authentication unit 17 outputs the result of authentication of the occupant of the vehicle, that is, personal information capable of identifying the occupant of the vehicle, to the protection mode selector 14a.

In addition to the above-described method, various methods may be used as a method of the occupant authentication unit 17 personally authenticating the occupant of the vehicle. The occupant authentication unit 17 may personally authenticate a person by a known method such as iris authentication and voiceprint authentication using voice. The occupant authentication unit 17 may personally authenticate the occupant of the vehicle by using an employee number and a signal indicating personal information such as a set password, which are manually input by the occupant of the vehicle or another person with an input unit (not illustrated). The occupant authentication unit 17 may personally authenticate the occupant of the vehicle by a method such as login to a predetermined system and collation of a work schedule with the current time.

The protection mode selector 14a decides whether or not protection of data is necessary based on the state of the occupant of the vehicle, which has been determined by the occupant state determination unit 13, and selects, as an encryption mode, a protection mode in which the data is protected by using a protection key based on a person authenticated by the occupant authentication unit 17. The protection mode selector 14a selects a protection key associated with the person authenticated by the occupant authentication unit 17 with reference to a protection key database (not illustrated) storing a registered person and a protection key for each registered person in association with each other. For example, when the occupant of the vehicle is in a state of being on a break, the protection mode selector 14a decides that privacy of the occupant of the vehicle is highly likely to be imaged in an image obtained by imaging the inside of the vehicle, which has been generated by the data generator 12, and that protection of the image data is necessary. Thereafter, a mode of protecting data is selected in which a protection key associated with the authenticated person, that is, the occupant of the vehicle is selected and data is protected with the protection key. For example, when the occupant of the vehicle is in a state of being engaged in business, the protection mode selector 14a decides that protection of the data generated by the data generator 12 is necessary, and selects a mode of protecting data, in which a protection key associated with the administrator of the vehicle or the business, different from the authenticated occupant of the vehicle, is selected and the data is protected by the protection key. This enables the protection mode selector 14a to set a data protection mode in which protection is performed by appropriately selecting a protection key set and managed by the occupant or the administrator of the vehicle and to select a data protection mode in which people who can decode or access data are appropriately reduced.

The protection mode selector 14a outputs the selected protection mode including whether or not protection of data is necessary to the data processor 15.

The protection mode selector 14a may select a protection mode associated with a person authenticated by the occupant authentication unit 17 with reference to a protection mode database storing a registered person and a protection mode for each registered person in association with each other. The protection mode in this case includes various protection modes, for example, whether protection is performed by a password, a common key encryption method, or a public key encryption method. The protection mode selector 14a may select a protection mode related to encryption strength, such as the bit number of an encryption method.

For example, when the occupant of the vehicle is in a state of being on a break and protection of data of an image obtained by imaging the inside of the vehicle is decided to be necessary, the protection mode selector 14a selects, as a mode of protecting data, a protection mode associated with an authenticated person, for example, a mode in which encryption is performed by a public key method, and selects protecting data in the protection method. This enables the protection mode selector 14a to set the strength of the data protection mode to a strength set by the occupant of the vehicle and to select a data protection mode in accordance with the intention of a person related to privacy protection.

Since pieces of processing of the data processor 15 and the output unit 16 are similar to those in the first embodiment, detailed descriptions thereof are omitted.

Next, a processing procedure of the vehicle information output device 10a according to the above-described second embodiment will be described with reference to a flowchart of FIG. 4. FIG. 4 is a flowchart illustrating an example of a processing procedure of a vehicle information output method according to the second embodiment. Note that the same step numbers are attached to steps similar to the pieces of processing in the first embodiment, and detailed descriptions thereof are omitted.

After Step S12, in Step S21, the occupant authentication unit 17 personally authenticates the occupant of the vehicle. The occupant authentication unit 17 recognizes the occupant of the vehicle as a specific person from an image obtained by imaging the inside of the vehicle, outputs the authentication result to the protection mode selector 14a, and proceeds to Step S22.

In Step S22, the protection mode selector 14a decides whether or not data protection is necessary based on the state of the occupant of the vehicle. When data is protected, the protection mode selector 14a selects a protection key for protecting data based on the person authenticated by the occupant authentication unit 17. For example, when the occupant of the vehicle is in a state of being on a break, the protection mode selector 14a decides that protection of image data is necessary, and selects a protection mode in which data is protected with a protection key associated with the authenticated occupant of the vehicle. The protection mode selector 14a outputs the selected data protection mode to the data processor 15, and proceeds to Step S14.

Since pieces of processing after Step S14 are similar to the pieces of processing in the first embodiment, detailed descriptions thereof are omitted.

As described above, according to the second embodiment, the vehicle information output device 10a can determine the state of the occupant of the vehicle, and personally authenticate the occupant of the vehicle. The vehicle information output device 10a can protect data that needs to be protected with a protection key or in a protection mode based on the authenticated occupant of the vehicle, and output the data.

The vehicle information output device 10a configured as described above can protect, as data, information on the privacy of the occupant of the vehicle with a protection key associated with and managed by the occupant of the vehicle or in a protection mode selected by the occupant of the vehicle. Furthermore, when mounted in a business-purpose vehicle or a general-purpose vehicle, which a plurality of people gets on or drives, the vehicle information output device 10a can determine the state of the occupant of the vehicle, and output information on the privacy of the occupant of the vehicle as data protected by a protection key different for each occupant of the vehicle or data protected in a protection mode different for each occupant of the vehicle.

### Third Embodiment

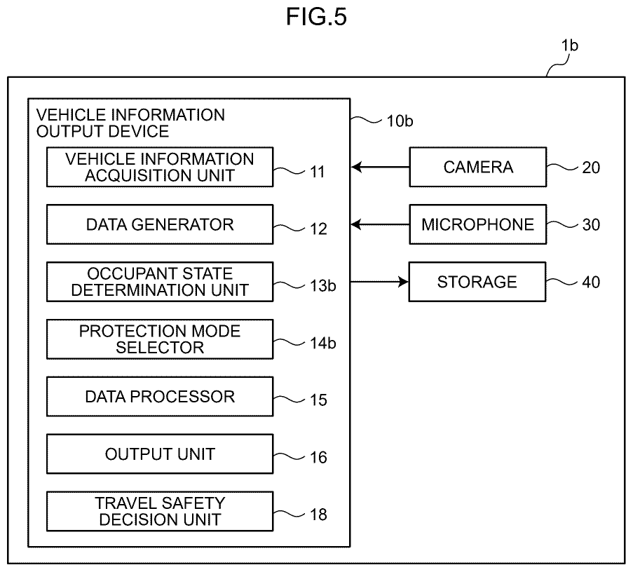

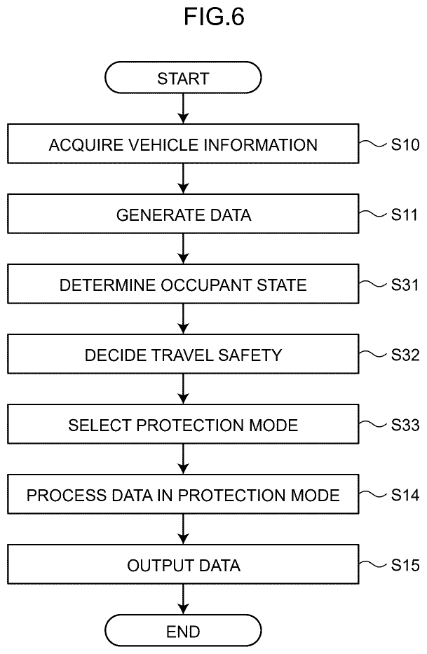

A third embodiment of the present disclosure will be described with reference to FIGS. 5 and 6. FIG. 5 is a block diagram illustrating an example of a configuration of a vehicle information output system 1b according to the third embodiment. The vehicle information output system 1b according to the third embodiment includes a vehicle information output device 10b. The vehicle information output device 10b has a configuration different from that of the vehicle information output device 10 according to the first embodiment in the following point.

That is, a travel safety decision unit 18, an occupant state determination unit 13b, and a protection mode selector 14b are provided. Since the vehicle information output device 10b has a configuration and a function similar to those of the vehicle information output device 10 according to the first embodiment except that the vehicle information output device 10b includes the travel safety decision unit 18, the occupant state determination unit 13b, and the protection mode selector 14b, detailed descriptions thereof are omitted. In the third embodiment, information on the safety of travel of the vehicle is used as first information on the vehicle. The travel safety decision unit 18 decides the safety of travel of the vehicle.

The vehicle information output device 10b according to the third embodiment of the present disclosure is provided typically in a vehicle for public. When the vehicle travels at a low level of safety, the vehicle information output device 10b achieves both reduction in the probability that data recording travel information on the vehicle cannot be decoded or accessed and appropriate protection of the privacy of the occupant of the vehicle. For example, a vehicle may cause a traffic accident. An occupant of the vehicle may be hospitalized for a long time, or may have only a vague memory after the accident. If data recording travel information in the case is protected by a protection key known only by the occupant of the vehicle, decoding of the record may be delayed or impossible. The vehicle information output device 10b achieves both reduction of such a risk and protection of the privacy of the occupant of the vehicle in a case where the vehicle is less likely to cause an accident. Furthermore, the vehicle information output device 10b can reduce a risk of the occupant of the vehicle concealing/hiding/falsifying travel information on the vehicle, such as an image obtained by imaging the inside of the vehicle, serving as evidence of a traffic accident when the occupant of the vehicle looked away or drove the vehicle in a state of low arousal to cause the traffic accident, for example.

The occupant state determination unit 13b determines the state of the occupant of the vehicle. For example, the occupant state determination unit 13b determines whether or not the occupant of the vehicle is in a sleeping state, is in an unconscious state, or has difficulty in driving the vehicle from an image obtained by imaging the inside of the vehicle and voice collected inside the vehicle, which have been acquired by the vehicle information acquisition unit 11. The occupant state determination unit 13b preferably includes an image recognizer (not illustrated) and a voice recognizer (not illustrated), which determine the state of the occupant of the vehicle from an image and voice. The occupant state determination unit 13b may decide the arousal or the brain activity state based on information from a wearable biosensor (not illustrated) worn by the occupant of the vehicle, and determine that the occupant of the vehicle is asleep or that his/her brain is activated. The occupant state determination unit 13b may determine that the occupant of the vehicle is completely drunk or is under the influence of alcohol based on information from an alcohol detector.

The occupant state determination unit 13b outputs the determined state of the occupant of the vehicle to the protection mode selector 14b.

The occupant state determination unit 13b may determine various states of the occupant of the vehicle in addition to the above-described states. The occupant state determination unit 13b preferably determines the state of the occupant of the vehicle by multiply using the above-described various types of information acquired by the vehicle information acquisition unit 11 and information acquired from other sensors.

The occupant state determination unit 13b may determine the state of the occupant of the vehicle by using a signal indicating that the occupant of the vehicle is in an emergency such as unconsciousness. The occupant of the vehicle or another person manually inputs the signal with an input unit (not illustrated).

The travel safety decision unit 18 acquires vehicle information from the vehicle information acquisition unit 11, and acquires the state of the occupant of the vehicle from the occupant state determination unit 13b. For example, the vehicle information acquired from the vehicle information acquisition unit 11 indicates whether the vehicle is traveling or stopped, whether or not the engine of the vehicle is stopped, and whether or not the parking brake is set. For example, the state of the occupant of the vehicle, which has been acquired from the occupant state determination unit 13b, is information on a state such as whether or not the occupant of the vehicle is in a sleeping state, is in an unconscious state, or has difficulty in driving the vehicle. The travel safety decision unit 18 decides the safety of travel of the vehicle, and sets information on the determined safety of travel of the vehicle as first information on the vehicle.

For example, when the vehicle is traveling and the occupant of the vehicle is in an unconscious state, the travel safety decision unit 18 determines that the vehicle is likely to run out of control, and decides the safety of travel of the vehicle as being at a low level. For example, when the engine of the vehicle is stopped, the parking brake is set, and the occupant of the vehicle is asleep, the travel safety decision unit 18 determines that the occupant of the vehicle is taking a nap after following an appropriate procedure of stopping the vehicle, and decides the safety of travel of the vehicle as being at a high level. The travel safety decision unit 18 may decide the safety of travel of the vehicle in a plurality of divided stages. In this case, the travel safety decision unit 18 preferably classifies the level of the travel safety of the vehicle by known techniques using, for example, the travel speed of the vehicle, the frequency of stepping on the brake, the road width of a road on which the vehicle is traveling, the curvature of a curve, a congestion degree, the arousal, body temperature, and eye opening of the occupant of the vehicle.

The travel safety decision unit 18 outputs the decided safety of travel of the vehicle to the protection mode selector 14b.

In addition to the above-described states, the travel safety decision unit 18 may decide the safety of travel of the vehicle in various states, which can be decided from the state of the occupant of the vehicle and vehicle information. The travel safety decision unit 18 preferably decides the level of the travel safety of the vehicle in a plurality of stages in accordance with various pieces of vehicle information and the state of the occupant of the vehicle. The various pieces of vehicle information include those in a case where the vehicle is traveling at a high speed, a case where the vehicle is traveling slowly, a case where the brake is stepped on and the vehicle is stopped, a case where the vehicle is stopped by the parking brake, a case where the engine is stopped, a case where a door is opened, and a case where the occupant of the vehicle does not sit in the driver seat of the vehicle. The state of the occupant of the vehicle includes those in a case where the occupant of the vehicle is gazing in the travel direction of the vehicle, a case where the occupant puts his/her hand on a steering wheel, a case where the occupant is looking away, a case where the occupant closes his/her eyes, and a case where the occupant is looking down. For example, when the engine of the vehicle is turned on, the vehicle is stopped, and the occupant of the vehicle is in a state of low arousal, the travel safety decision unit 18 judges that the occupant of the vehicle has fallen asleep while the vehicle is stopped at a red light, and decides the safety of travel of the vehicle as being at a medium level.

The protection mode selector 14b selects a protection mode including whether or not protection of data is necessary based on the safety of travel of the vehicle, which has been determined by the travel safety decision unit 18. For example, when the safety of travel of the vehicle is lower than a predetermined reference level, the protection mode selector 14b sets protection of data as unnecessary, or selects the data protection mode using a protection key based on a person different from the occupant of the vehicle, in other words, a person not on board the vehicle in order to prioritize output of information on travel of the vehicle in a state in which the information can be decoded or accessed over the privacy of the occupant of the vehicle. When the safety of travel of the vehicle is at a low level, the protection mode selector 14b may select a mode of protecting data by using a specific protection key known by a plurality of predetermined people. For example, when the safety of travel of the vehicle is higher than the predetermined reference level, the protection mode selector 14b selects a mode of protecting data by using a specific protection key known only by a predetermined occupant of the vehicle in order to prioritize the privacy of the occupant of the vehicle.

The protection mode selector 14b outputs the selected protection mode including whether or not protection of data is necessary to the data processor 15.

Since pieces of processing of the data processor 15 and the output unit 16 are similar to those in the first embodiment, detailed descriptions thereof are omitted.

Next, a processing procedure of the vehicle information output device 10b according to the above-described third embodiment will be described with reference to a flowchart of FIG. 6. FIG. 6 is a flowchart illustrating an example of a processing procedure of a vehicle information output method according to the third embodiment. Note that the same step numbers are attached to steps similar to the pieces of processing in the first embodiment, and detailed descriptions thereof are omitted.

After Step S11, in Step S31, the occupant state determination unit 13b determines the state of the occupant of the vehicle, for example, whether or not the occupant of the vehicle is in a sleeping state, is in an unconscious state, or has difficulty in driving the vehicle. The occupant state determination unit 13b outputs the determined state of the occupant of the vehicle to the travel safety decision unit 18, and proceeds to Step S32.

In Step S32, the travel safety decision unit 18 decides the safety of travel of the vehicle. For example, when the vehicle is traveling and the occupant of the vehicle is in an unconscious state, the travel safety decision unit 18 decides the safety of travel of the vehicle as being at a low level. The travel safety decision unit 18 outputs the decided safety of travel of the vehicle to the protection mode selector 14b, and proceeds to Step S33.

In Step S33, the protection mode selector 14b selects a data protection mode including whether or not data protection is necessary based on the safety of travel of the vehicle. For example, when the safety of travel of the vehicle is at a low level, the protection mode selector 14b selects a mode of protecting data by using a specific protection key known by a plurality of predetermined people. The protection mode selector 14b outputs the selected data protection mode to the data processor 15, and proceeds to Step S14.

Since pieces of processing after Step S14 are similar to the pieces of processing in the first embodiment, detailed descriptions thereof are omitted.

As described above, according to the third embodiment, the vehicle information output device 10b can decide the safety of travel of the vehicle, select a protection mode of data containing vehicle information based on the safety of travel of the vehicle, and output data protected in the selected mode.

The vehicle information output device 10b configured as described above enables appropriately protecting and outputting information on the privacy of the occupant of the vehicle in a selected protection mode and outputting travel information on travel of the vehicle in a mode in which the travel information can be appropriately managed to be switched between based on the determined travel safety, and can achieve both thereof. For example, when the safety of travel of the vehicle is high and a traffic accident is less likely to occur, the vehicle information output device 10b determines that now is a private time when the privacy of the occupant of the vehicle should be respected, and selects the data protection mode using a protection key based on the occupant of the vehicle. For example, when the safety of travel of the vehicle is low and a traffic accident is likely to occur, the vehicle information output device 10b selects the data protection mode using a protection key based on a person different from the occupant of the vehicle, in other words, a person not on board the vehicle in order to prioritize output of information on travel of the vehicle in a state in which the information can be decoded or accessed. Using different protection keys for protecting data between a case of a low level of safety of travel of the vehicle and a case of a high level of safety of travel of the vehicle enables an appropriate person to decode or access protected data.

### Fourth Embodiment

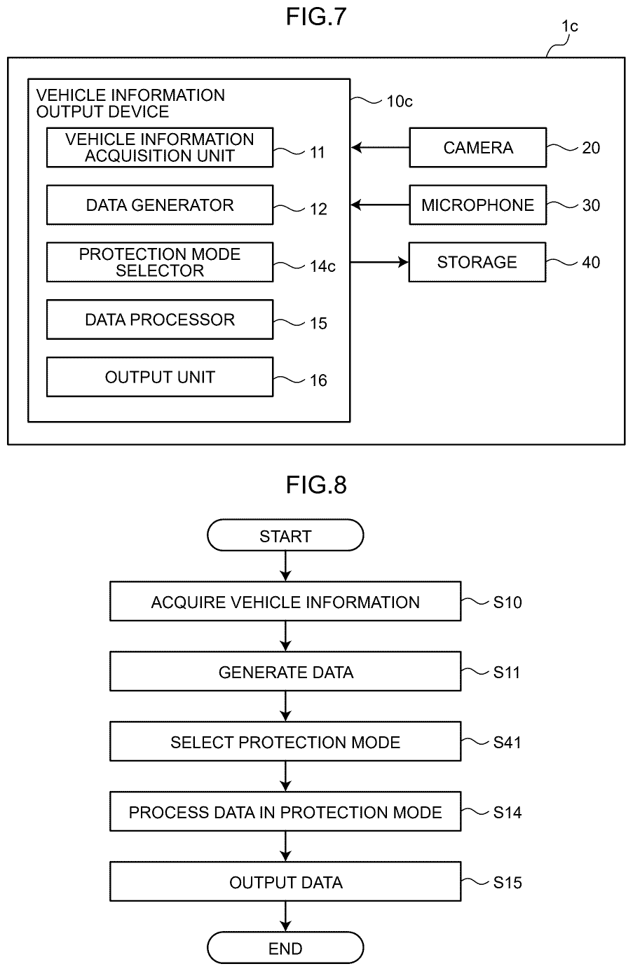

A fourth embodiment of the present disclosure will be described with reference to FIGS. 7 and 8. FIG. 7 is a block diagram illustrating an example of a configuration of a vehicle information output system 1c according to the fourth embodiment. The vehicle information output system 1c according to the fourth embodiment includes a vehicle information output device 10c. The vehicle information output device 10c has a configuration different from that of the vehicle information output device 10 according to the first embodiment in the following point.

That is, a protection mode selector 14c is provided. Since the vehicle information output device 10c has a configuration and a function similar to those of the vehicle information output device 10 according to the first embodiment except that the vehicle information output device 10c includes the protection mode selector 14c, detailed descriptions thereof are omitted. In the fourth embodiment, vehicle information acquired by the vehicle information acquisition unit 11, for example, information on opening and closing of a door of the vehicle is used as first information on the vehicle.

The vehicle information output device 10c according to the fourth embodiment of the present disclosure is provided typically in a business-purpose vehicle. The vehicle information output device 10c achieves both maintenance of vehicle information and protection of the privacy of the occupant of the vehicle in a case where an occupant including a passenger of the vehicle is getting on and off the vehicle or in a case where the vehicle is loading or unloading baggage. For example, when a door of the vehicle is opened, the occupant of the vehicle is often getting on and off, or the vehicle is often loading or unloading baggage. An image obtained by imaging the surroundings of the vehicle and collected voice are records in business. Thus, it is preferable that the vehicle information can be output in a mode in which an administrator of the vehicle or the business can easily browse the vehicle information and information on business can be appropriately managed. When a driver of the vehicle is nearby outside the vehicle, however, the camera 20 that images the surroundings of the vehicle does not necessarily image an appropriate region. The occupant state determination unit 13 in the vehicle information output device 10 according to the above-described first embodiment may fail to appropriately determine the occupant state. Even in such a case, the vehicle information output device 10c achieves both appropriate management of travel information on travel of the vehicle and protection of the privacy of the occupant of the vehicle.

The protection mode selector 14c uses the vehicle information acquired by the vehicle information acquisition unit 11 as first information, and selects a protection mode including whether or not protection of data is necessary based on the first information. For example, the protection mode selector 14c selects the protection mode including whether or not protection of data is necessary at least based on whether or not the acquired vehicle information indicates the opened state of the door of the vehicle. When the acquired vehicle information indicates the opened state of the door of the vehicle, the protection mode selector 14c sets protection of data as unnecessary, or selects a data protection mode using a protection key known by an administrator of the vehicle or a plurality of people in order to achieve a form in which the administrator of the vehicle or the plurality of people can easily decode or access the data. When the acquired vehicle information indicates the closed state of the door of the vehicle, the protection mode selector 14c selects a data protection mode using a protection key known by the occupant of the vehicle in order to achieve a mode in which a third party cannot decode or access the data. The protection key is preferably selected with reference to correspondence information in which each piece of vehicle information is associated with the protection key. For example, the correspondence information indicates information on protection keys for each of a case where vehicle information indicates the opened state of the door and a case where the vehicle information indicates the closed state of the door. The protection mode selector 14c outputs the selected protection mode including whether or not protection of data is necessary to the data processor 15.

In the case, the door of the vehicle is not limited to a door used for the occupant of the vehicle to get on and off the vehicle. The door of the vehicle includes a rear gate of the vehicle, a trunk cover (lid) of the vehicle, and an emergency exit of, for example, a bus. The door of the vehicle is a part that can be opened and closed on an exterior of the vehicle. The part includes an engine room cover of the vehicle. The door of the vehicle preferably includes a part where traveling with the part being opened is prohibited or not recommended or a part where it is not preferable that an occupant leave the vehicle with the part being opened.

These doors are highly likely to be opened in a case where the occupant of the vehicle is getting on and off the vehicle, a case where baggage mounted in the vehicle is loaded or unloaded, or a case where the state check or maintenance around the engine of the vehicle is performed. In such a situation, the occupant may be injured, and baggage may be damaged. Furthermore, a business-purpose vehicle is highly likely to be at business. For example, when a door of the vehicle is opened, the protection mode selector 14c may set protection of data as unnecessary, or select a data protection mode using a protection key known by an administrator of the vehicle or a plurality of people in order for the administrator of the vehicle or the plurality of people to decode or access the data. For example, when the door of the vehicle is closed and the engine of the vehicle is stopped, the protection mode selector 14c determines that now is a private time when the privacy of the occupant of the vehicle should be respected, and selects a data protection mode using a protection key known by the occupant of the vehicle to prevent the administrator of the vehicle and a third party from easily decoding or accessing the data.

The protection mode selector 14c may select the protection mode including whether or not protection of data is necessary at least based on whether or not the acquired vehicle information indicates the locked state of the door of the vehicle. When the door of the vehicle is not locked, the occupant of the vehicle often does not leave the vehicle, and the occupant of the vehicle is highly likely to be at business near the vehicle. Protection of data is determined as unnecessary, or a mode of protecting data in a form in which the administrator of the vehicle can decode or access the data is selected.

Since pieces of processing of the data processor 15 and the output unit 16 are similar to those in the first embodiment, detailed descriptions thereof are omitted.

Next, a processing procedure of a monitoring device according to the above-described fourth embodiment will be described with reference to a flowchart of FIG. 8. FIG. 8 is a flowchart illustrating an example of a processing procedure of a vehicle information output method according to the fourth embodiment. Note that the same step numbers are attached to steps similar to the pieces of processing in the first embodiment, and detailed descriptions thereof are omitted.

After Step S11, in Step S41, the protection mode selector 14c selects a data protection mode including whether or not data protection is necessary based on the acquired vehicle information. For example, when the vehicle information indicates that the door of the vehicle is opened, the protection mode selector 14c selects a mode of protecting data by using a specific protection key known by a plurality of predetermined people. The protection mode selector 14c outputs the selected data protection mode to the data processor 15, and proceeds to Step S14.

Since pieces of processing after Step S14 are similar to the pieces of processing in the first embodiment, detailed descriptions thereof are omitted.

As described above, according to the fourth embodiment, the vehicle information output device 10c can select a protection mode of data containing vehicle information based on the acquired vehicle information, and output data protected in the selected mode.

When the vehicle is in a state related to business or the occupant may be injured or baggage may be damaged, the vehicle information output device 10c configured as described above enables appropriately outputting travel information on travel of the vehicle in a mode in which the travel information can be appropriately managed and appropriately protecting and outputting information on the privacy of the occupant of the vehicle in a selected protection mode to be switched between, and can achieve both thereof. Using different protection keys for protecting data between a case where the door of the vehicle is opened and a case where the door of the vehicle is closed can enable an appropriate person to decode or access protected data, and prevent an inappropriate person from easily decoding or accessing the protected data.

### Fifth Embodiment

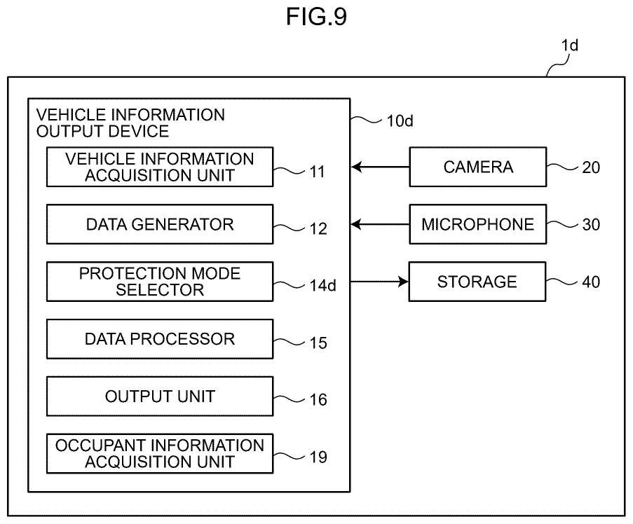

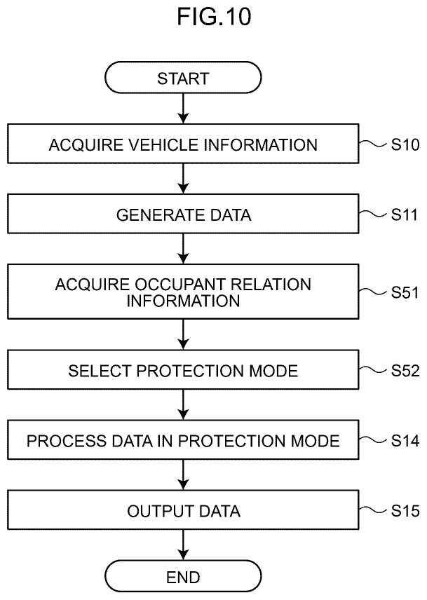

A fifth embodiment of the present disclosure will be described with reference to FIGS. 9 and 10. FIG. 9 is a block diagram illustrating an example of a configuration of a vehicle information output system 1d according to the fifth embodiment. The vehicle information output system 1d according to the fifth embodiment includes a vehicle information output device 10d. The vehicle information output device 10d has a configuration different from that of the vehicle information output device 10 according to the first embodiment in the following point.

That is, an occupant information acquisition unit 19 and a protection mode selector 14d are provided. Since the vehicle information output device 10d has a configuration and a function similar to those of the vehicle information output device 10 according to the first embodiment except that the vehicle information output device 10d includes the occupant information acquisition unit 19 and the protection mode selector 14d, detailed descriptions thereof are omitted. In the fifth embodiment, information on the occupant of the vehicle, which is acquired by the occupant information acquisition unit 19, for example, information on the relation between a driver and a passenger of the vehicle is used as first information on the vehicle.

The vehicle information output device 10d according to the fifth embodiment of the present disclosure selects a protection mode preliminarily determined for each relation between the driver and the passenger based on the relation between the driver and the passenger of the vehicle, and maintains vehicle information in the selected protection mode. The vehicle information output device 10d can use different modes of protecting data in respective cases of, for example, a case where only the driver is on board the vehicle, a case where a family including the driver is on board the vehicle, and a case where the driver and his/her acquaintance are on board the vehicle. In the above-described cases, a data protection mode in the case is preferably adopted in which all the occupants of the vehicle can decode or access the data and a person other than the occupants cannot decode or access the data. As described above, the fifth embodiment partially has a problem different from those in the above-described first to fourth embodiments. The fifth embodiment has a problem of appropriately managing vehicle information for each relation between the occupants of the vehicle, and has a configuration to be described later as a solution therefor.

The occupant information acquisition unit 19 acquires information on the relation between the driver and the passenger of the vehicle, and sets the acquired information on the relation between the driver and the passenger of the vehicle as first information on the vehicle. The occupant information acquisition unit 19 acquires information on the driver of the vehicle and the passenger on board the vehicle together, and acquires information on the relation between the driver and the passenger of the vehicle by using correspondence information to be described later, in which the relation between the driver and the passenger of the vehicle is associated with the information on the driver of the vehicle and the passenger on board the vehicle together. The occupant information acquisition unit 19 outputs the acquired information on the relation between the driver and the passenger of the vehicle to the protection mode selector 14d.

The occupant information acquisition unit 19 acquires information on the driver of the vehicle or the passenger on board the vehicle together by personally authenticating the driver or the passenger of the vehicle from, for example, an image or voice acquired by the vehicle information acquisition unit 11. The image has been obtained by imaging the inside of the vehicle. The voice has been collected inside the vehicle. The occupant information acquisition unit 19 may acquire personal names of the driver and the passenger and information on the relation therebetween with an input unit (not illustrated), for example, a voice input unit that inputs voice. The occupant information acquisition unit 19 may acquire the information on the driver and the passenger of the vehicle as information such as personal names and nicknames input by the driver and the passenger through a touch panel. In the case, buttons indicating the relation of, for example, an “occupant A alone”, “family of the occupant A”, an “acquaintance group of the occupant A”, and “colleague group of an occupant B” may be displayed on the touch panel. The relation between the driver and the passenger of the vehicle is directly acquired by pressing any button on the touch panel. The occupant information acquisition unit 19 may acquire information on the driver and the passenger of the vehicle by using identification (ID) information acquired from mobile devices of the driver and the passenger of the vehicle. Examples of the ID information include information obtained by receiving identification information on Bluetooth (registered trademark) transmitted by a smartphone and person correspondence information in which a person is associated with the received identification information.

The occupant information acquisition unit 19 preferably acquires information on the relation between the driver and the passenger of the vehicle by using the relation correspondence information in which the information on the driver and the passenger of the vehicle is associated with the relation between the driver and the passenger of the vehicle. In the case, the relation correspondence information is obtained by defining the relation between people acquired as personal information. In the relation correspondence information, the relations between people of the driver and passengers are registered and associated. Examples of the relations include the occupant A, the occupant A and the occupant B who is a spouse of the occupant A, an occupant C and an occupant D who are family of the occupant A and the occupant B, a friend of the occupant A, and a colleague of the occupant B. The vehicle information output device 10d or the storage 40 preferably store the person correspondence information and the relation correspondence information described above.

The protection mode selector 14d selects a protection mode including whether or not protection of data is necessary based on the relation between the driver and the passenger, which has been acquired by the occupant information acquisition unit 19. The protection mode selector 14d prevents a third party from easily decoding or accessing the data by selecting a data protection mode using a protection key known by the driver of the vehicle and the occupant of the vehicle, who is a passenger of the vehicle. The data protection mode is preliminarily determined for each relation between the driver and the passenger of the vehicle. The protection key is preferably selected with reference to correspondence information in which the relation between the driver and the passenger is associated with a protection key. The correspondence information indicates information on protection keys for respective cases of, for example, a case of relation of the driver alone and a case of relation of an acquaintance of the driver. The protection mode selector 14d outputs the selected protection mode including whether or not protection of data is necessary to the data processor 15.

For example, when the relation acquired by the occupant information acquisition unit 19 is the “acquaintance group of the occupant A”, the protection mode selector 14d selects a mode of protecting data in a protection mode preliminarily determined for the “acquaintance group of the occupant A”. Preliminarily determining a protection mode for the “acquaintance group of the occupant A” means deciding that protection of data is necessary and selecting a data protection mode using a protection key known by the occupant A and the acquaintance who is a passenger. When the acquired relation is the “family of the occupant A”, the protection mode selector 14d may select a data protection mode using a protection key known by all family members or a predetermined part of the family of the occupant A, or decide that protection of data is unnecessary.

Since pieces of processing of the data processor 15 and the output unit 16 are similar to those in the first embodiment, detailed descriptions thereof are omitted.

Next, a processing procedure of a monitoring device according to the above-described fifth embodiment will be described with reference to a flowchart of FIG. 10. FIG. 10 is a flowchart illustrating an example of a processing procedure of a vehicle information output method according to the fifth embodiment. Note that the same step numbers are attached to steps similar to the pieces of processing in the first embodiment, and detailed descriptions thereof are omitted.

After Step S11, in Step S51, the occupant information acquisition unit 19 acquires information on the occupant of the vehicle, and acquires information on the relation between the driver and the passenger of the vehicle. The occupant information acquisition unit 19 outputs the acquired information on the relation between the driver and the passenger of the vehicle to the protection mode selector 14d, and proceeds to Step S52.

In Step S52, the protection mode selector 14d selects a protection mode including whether or not protection of data is necessary based on the acquired relation between the driver and the passenger of the vehicle. When the acquired relation is the “acquaintance group of the occupant A”, the protection mode selector 14d selects a mode of protecting data in a protection mode preliminarily determined for the “acquaintance group of the occupant A”. The protection mode selector 14d outputs the selected data protection mode to the data processor 15, and proceeds to Step S14.

Since pieces of processing after Step S14 are similar to the pieces of processing in the first embodiment, detailed descriptions thereof are omitted.

As described above, according to the fifth embodiment, the vehicle information output device 10d can select a protection mode of data containing vehicle information based on the acquired relation between the driver and the passenger of the vehicle, and output data protected in the selected mode.

The vehicle information output device 10d configured as described above can appropriately manage vehicle information for each relation between the occupants of the vehicle. The vehicle information output device 10d protects and outputs information on the privacy of the driver on board the vehicle and the occupant who is a passenger in a protection mode preliminarily determined for each relation between the driver and the passenger. The vehicle information output device 10d can protect data in such a mode that a person other than a person on board the vehicle cannot easily browse travel information on the vehicle. The vehicle information output device 10d can enable an appropriate person to decode or access protected data, and prevent an inappropriate person from easily decoding or accessing the protected data by using different protection keys for protecting data for each relation between occupants on board the vehicle.

### Sixth Embodiment

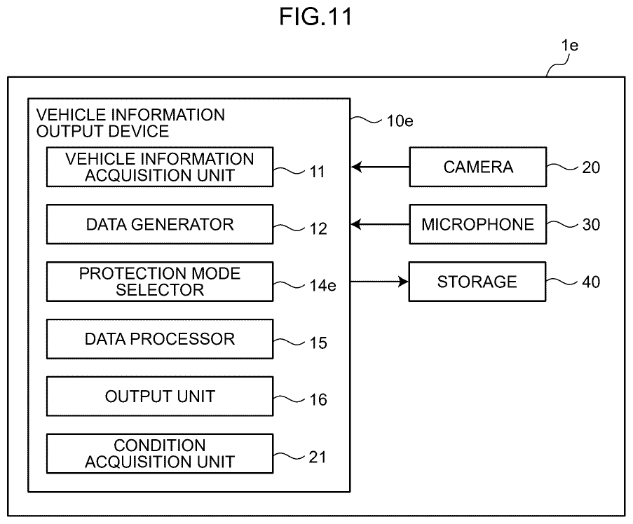

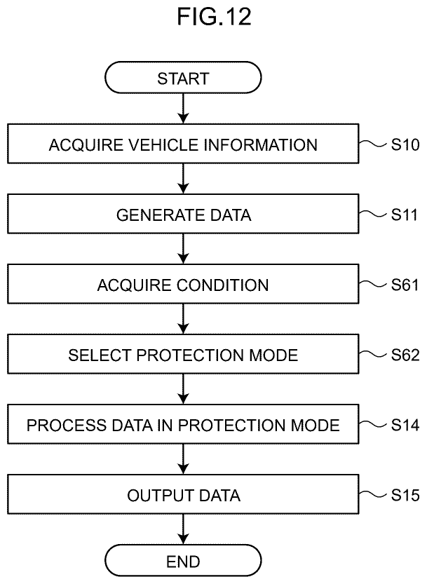

A sixth embodiment of the present disclosure will be described with reference to FIGS. 11 and 12. FIG. 11 is a block diagram illustrating an example of a configuration of a vehicle information output system 1e according to the sixth embodiment. The vehicle information output system 1e according to the sixth embodiment includes a vehicle information output device 10e. The vehicle information output device 10e has a configuration different from that of the vehicle information output device 10 according to the first embodiment in the following point.

That is, a condition acquisition unit 21 and a protection mode selector 14e are provided. Since the vehicle information output device 10e has a configuration and a function similar to those of the vehicle information output device 10 according to the first embodiment except that the vehicle information output device 10e includes the condition acquisition unit 21 and the protection mode selector 14e, detailed descriptions thereof are omitted. In the sixth embodiment, information on a first condition and a second condition acquired by the condition acquisition unit 21 is used as first information on the vehicle.

The vehicle information output device 10e according to the sixth embodiment of the present disclosure is mounted in a vehicle whose administrator is different from an occupant of the vehicle, such as typically a rental car and a leased vehicle. The vehicle information output device 10e achieves both protection of privacy under a condition in which the occupant of the vehicle wants concealment and maintenance of vehicle information in a case where the occupant of the vehicle causes an accident or damages the vehicle. When the occupant of the vehicle parks a rental car in, for example, his/her home, an image obtained by imaging the surroundings of his/her home is acquired as vehicle information. In the case, the vehicle information may identify his/her home. Furthermore, conversations in the vehicle between occupants of the vehicle are private, and may be sensitive in some cases. Thus, in some cases, the occupant of the vehicle does not want the administrator of the vehicle of, for example, a rental-car company to know such images and conversation contents. If these pieces of vehicle information are protected by a protection key known by the occupant of the vehicle, however, the occupant of the vehicle may fail to successfully decode or access data containing vehicle information. Furthermore, it is assumed that the occupant of the vehicle hides the data. Thus, the administrator of the vehicle demands to maintain the vehicle information in such a manner that the vehicle information can be decoded or accessed in cases where the vehicle causes an accident, where the vehicle is damaged, and where there is a criminal action inside or outside the vehicle. As described above, the sixth embodiment partially has a problem different from those in the above-described first to fifth embodiments. The sixth embodiment has a problem of appropriately selecting a mode of protecting vehicle information under the condition in which the occupant of the vehicle wants to protect privacy, and has a configuration to be described later as a solution therefor.

The condition acquisition unit 21 acquires the first condition and the second condition related to protection of the generated data, and sets the acquired first condition and second condition as first information on the vehicle. The condition acquisition unit 21 preferably includes an input unit (not illustrated) that inputs the first condition and the second condition. The input unit may be, for example, a voice input unit that inputs voice and a touch panel. The input unit may be a receiver that receives the first condition and the second condition via a communicator (not illustrated). The first condition and the second condition are set in a mobile device of the occupant of the vehicle or other external devices. The condition acquisition unit 21 may acquire a condition preliminarily stored in the vehicle information output device 10e or the storage 40 as the first condition and the second condition. The condition acquisition unit 21 outputs the acquired first condition and second condition to the protection mode selector 14e.

Although the first condition acquired by the condition acquisition unit 21 may preferably be a condition related to vehicle information, a condition related to the occupant of the vehicle, and a condition related to the environment around the traveling vehicle, which have been designated by the occupant of the vehicle, the first condition is not limited thereto. The first condition is designated as a condition that the occupant of the vehicle wants concealment. The first condition is, for example, a region around the home of the occupant of the vehicle or on a map including a destination. The occupant of the vehicle wants to conceal an image captured in the region, an address, and a visit point as tightly as possible. The first condition may be a condition related to, for example, whether or not the occupant of the vehicle makes a speech or whether or not a predetermined object is recognized in an image captured by the camera 20. When the occupant of the vehicle wants to protect, as privacy, information to be concealed, the occupant of the vehicle designates the first condition. The information to be concealed includes the contents of a conversation with the passenger and information capable of identifying a place and an environment in which the vehicle is traveling. The first condition may include a predetermined form in which no special restriction is imposed.

The second condition acquired by the condition acquisition unit 21 is a condition related to protection of data. For example, the second condition is a condition for determining the level of encryption strength in a protection mode of data to be protected, which is set by the administrator of the vehicle. The second condition is a condition set by the administrator of the vehicle determining strength of protection of data to be protected, for example, encryption strength in encrypting data as a condition in a case where the privacy of the occupant of the vehicle is protected. The second condition may be designation of an encryption algorithm for encrypting data to be protected. The second condition is preferably a condition having encryption strength equal to or greater than a predetermined level of strength so that the privacy of the occupant of the vehicle can be protected. The second condition is preferably set as a condition having a vulnerability and being at a level at which data can be decoded or accessed by investing necessary efforts. This achieves a mode in which data can be decoded or accessed by investing efforts even when the vehicle causes an accident to cause the occupant to fall unconscious and forget a protection key for protecting data or even when the occupant of the vehicle takes a criminal action inside or outside the vehicle and attempts to hide data serving as evidence thereof. For example, the second condition can be set as a protection mode at a level at which data can be decoded or accessed by using a supercomputer but decoding or accessing the data by using a popularized computer is difficult in practice.

The second condition may be set as an option of a password in a case where data is protected by a password or a case where accessing the data is prohibited. In other words, the second condition may be a limiting condition for limiting options of a protection key for protecting data. For example, the administrator of the vehicle may adopt a form in which a second condition is set by limiting passwords for protecting travel information on the vehicle to four-digit numbers and the occupant of the vehicle optionally selects a password from the options. For example, in this case, the administrator of the vehicle can find a password for protecting data through up to 10,000 brute-force tests. The second condition is preferably set based on the type of data to be protected or the contents of the first condition set by the occupant of the vehicle. For example, when the occupant of the vehicle desires to protect all pieces of information acquired by the vehicle and sets the first condition as “no limit”, the second condition can be set as a protection mode in which data can be decoded or accessed relatively easily.

The protection mode selector 14e selects a protection mode including whether or not protection of data generated by the data generator 12 is necessary at least based on the first condition and the second condition. For example, the protection mode selector 14e compares vehicle information acquired by the vehicle information acquisition unit 11 with the first condition acquired by the condition acquisition unit 21. When the acquired vehicle information satisfies the first condition, for example, the protection mode selector 14e decides to protect data, and selects a protection mode at least based on the second condition. For example, the protection mode selector 14e may compare the information acquired or determined in another embodiment of the present disclosure with the first condition acquired by the condition acquisition unit 21. The information includes an occupant state determined by the occupant state determination unit 13 and occupant information acquired by the occupant information acquisition unit 19. The protection mode selector 14e outputs the selected protection mode including whether or not protection of data is necessary to the data processor 15.

For example, when the occupant of the vehicle designates a predetermined region on a map as the first condition and it is indicated that the acquired current position of the vehicle is within the region, the protection mode selector 14e decides to protect data containing vehicle information, such as an image, voice, and the current position of the vehicle, which have been acquired by the vehicle information acquisition unit 11. When the first condition is designated as identification (ID) of the vehicle such as an automobile registration number of the vehicle and the ID of the vehicle, which has been acquired by the vehicle information acquisition unit 11, indicates the designated vehicle, the protection mode selector 14e determines that the first condition has been satisfied, and decides to protect the data containing vehicle information.

Sequentially, the protection mode selector 14e selects a protection mode of data decided to be protected based on the second condition. For example, when the administrator of the vehicle designates encryption using an encryption algorithm having a vulnerability as the second condition, the protection mode selector 14e selects a mode in which generated data is encrypted by using a selected encryption algorithm, and selects a data protection mode using a protection key set by the occupant of the vehicle. In the case, the encryption algorithm having a vulnerability refers to an encryption algorithm having a small number of bits of a key length, and is an algorithm in which a vulnerability is found or an algorithm whose use is not recommended. When the administrator of the vehicle sets options of protection keys for protecting data in a limited manner, the protection mode selector 14e selects a data protection mode using a protection key selected by the occupant of the vehicle from the options.

For example, the protection mode selector 14e sets a data protection mode in a case where the vehicle information acquired by the vehicle information acquisition unit 11 does not satisfy the first condition as a data protection mode in which data is not protected or a protection key known by the administrator of the vehicle or a plurality of people is used.

Since pieces of processing of the data processor 15 and the output unit 16 are similar to those in the first embodiment, detailed descriptions thereof are omitted.

Next, a processing procedure of a monitoring device according to the above-described sixth embodiment will be described with reference to a flowchart of FIG. 12. FIG. 12 is a flowchart illustrating an example of a processing procedure of a vehicle information output method according to the sixth embodiment. Note that the same step numbers are attached to steps similar to the pieces of processing in the first embodiment, and detailed descriptions thereof are omitted.

After Step S11, in Step S61, the condition acquisition unit 21 acquires the first condition. Furthermore, the condition acquisition unit 21 acquires the second condition related to protection of data. The condition acquisition unit 21 outputs the acquired first condition and second condition to the protection mode selector 14e, and proceeds to Step S62.

In Step S62, for example, when the vehicle information satisfies the first condition, the protection mode selector 14e selects a protection mode including whether or not protection of data is necessary based on the second condition. For example, when the vehicle is located within a region set by the occupant of the vehicle, the protection mode selector 14e decides that protection of data is necessary, and selects a protection mode using a protection key set based on the second condition. The protection mode selector 14e outputs the selected data protection mode to the data processor 15, and proceeds to Step S14.

Since pieces of processing after Step S14 are similar to the pieces of processing in the first embodiment, detailed descriptions thereof are omitted.

As described above, according to the sixth embodiment, for example, when travel information on the vehicle satisfies the first condition, the vehicle information output device 10e can select a protection mode of data containing vehicle information based on the second condition designated by the administrator of the vehicle, and output data protected in the selected mode.

The vehicle information output device 10e configured as described above enables the occupant on the vehicle, for example, a user who has rented a rental car to protect data containing vehicle information under a condition in which privacy is desired to be protected. The protection mode is protection based on the second condition designated by the administrator of the vehicle, for example, a protection mode having a vulnerability or a protection mode of protecting data with a protection key in which options are limited. When an accident or damage occurs to the vehicle and the occupant of the vehicle attempts to hide data serving as evidence thereof, the administrator of the vehicle can decode or access the data by using the vulnerability of the encryption algorithm determined as the second condition. When the occupant of the vehicle designates the first condition, the vehicle information output device 10e can prevent an inappropriate person from easily decoding or accessing protected data by setting a protection mode of protecting data as protection using a protection key based on the second condition designated by the administrator of the vehicle, and can enable an appropriate person to decode or access the data by taking a procedure, such as conducting a brute-force test, as necessary.

### Seventh Embodiment

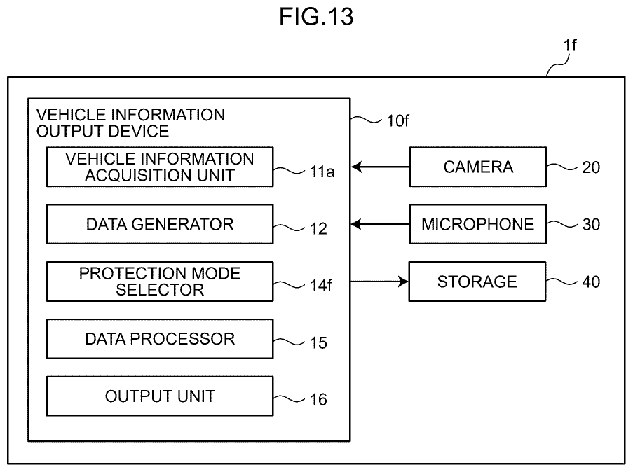

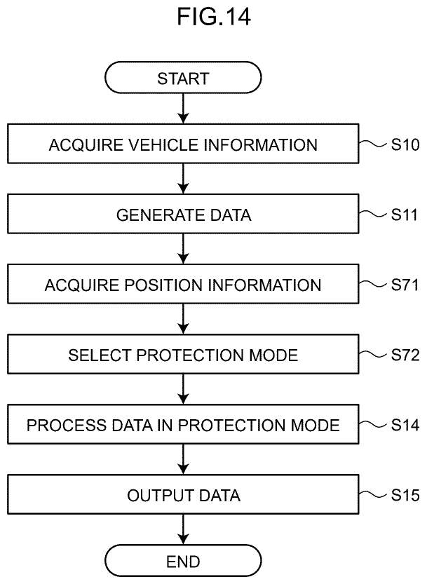

A seventh embodiment of the present disclosure will be described with reference to FIGS. 13 and 14. FIG. 13 is a block diagram illustrating an example of a configuration of a vehicle information output system if according to the seventh embodiment. The vehicle information output system if according to the seventh embodiment includes a vehicle information output device 10f. The vehicle information output device 10f has a configuration different from that of the vehicle information output device 10 according to the first embodiment in the following point.

That is, a vehicle information acquisition unit 11a and a protection mode selector 14f are provided. Since the vehicle information output device 10f has a configuration and a function similar to those of the vehicle information output device 10 according to the first embodiment except that the vehicle information output device 10f includes the vehicle information acquisition unit 11a and the protection mode selector 14f, detailed descriptions thereof are omitted. In the seventh embodiment, position information on the vehicle, which is acquired by the vehicle information acquisition unit 11a, for example, information on the current position or the destination of the vehicle is used as first information on the vehicle.

The vehicle information output device 10f according to the seventh embodiment of the present disclosure is provided typically in a business-purpose vehicle. When maintenance of confidentiality related to the current position and the destination of the vehicle is necessary, the vehicle information output device 10f selects a protection mode preliminarily determined for each of the current position and the destination, and maintains the vehicle information in the selected protection mode. A business-purpose vehicle may travel to a plurality of customer places as destinations, and perform a baggage loading or unloading operation or have a business conversation at each of the customer places. An image obtained by imaging the operation, voice obtained by collecting the conversation, the position information on visit facilities of the customer place, and the like are preferably managed for each customer place. A customer place and a route to the customer place can be estimated by the position information on a traveling vehicle, so that the position information is preferably set as a management target. In such a case, appropriate management of the vehicle information is required. In the case, the appropriate management means setting, for example, a protection mode in which only a limited person concerned such as a person in charge of a customer can perform browsing. As described above, the seventh embodiment partially has a problem different from those in the above-described first to sixth embodiments. The seventh embodiment has a problem of appropriately managing vehicle information for each region of the current position and the destination of the vehicle, and has a configuration to be described later as a solution therefor.

The vehicle information acquisition unit 11a acquires position information containing the current position of the vehicle as vehicle information, and sets the acquired position information on the vehicle as first information on the vehicle. The vehicle information acquisition unit 11a may acquire information on the current position of the vehicle in a configuration similar to that of the above-described vehicle information acquisition unit 11, or may include a destination information acquisition unit (not illustrated), which is information in which a destination of the vehicle is set. In the case, the destination may be a collective term including a transit point through which the vehicle travels to the destination. For example, the destination information acquisition unit is connected to a navigation device (not illustrated) mounted in the vehicle by wire or wirelessly, and acquires information on the destination of the vehicle, which has been set in the navigation device. The destination information acquisition unit preferably includes an input unit (not illustrated) that inputs a destination. The input unit may be, for example, a voice input unit that inputs voice and a touch panel.

The protection mode selector 14f selects a protection mode including whether or not protection of data is necessary at least based on the position information on the vehicle. For example, when the current position of the vehicle is within a predetermined region, the protection mode selector 14f selects a data protection mode using a protection key known by a person preliminarily determined for each region. For example, when the current position of the vehicle is not within the predetermined region, the protection mode selector 14f sets protection of data as unnecessary, or selects a data protection mode using a protection key known by an administrator of the vehicle or a plurality of people in order to prioritize output of information on travel of the vehicle in a state in which the information can be easily decoded or accessed. The protection key is preferably selected with reference to correspondence information on protection keys associated with regions. The correspondence information indicates information on protection keys determined for each region, such as a protection key A in a case where the position of the vehicle is within the region and a protection key B in a case where the position information on the vehicle is within a second region. The protection mode selector 14f outputs the selected protection mode including whether or not protection of data is necessary to the data processor 15.

For example, the inside of the above-described predetermined region is preferably the inside of visit facilities of a customer place or a region preliminarily determined for each customer as a range in which the place of the visit facilities or the route to the visit facilities can be estimated. For example, for a customer A, a region within a predetermined distance from the facility position of the customer A may be set as a region A corresponding to the customer A. For a visit facility B, a region from a point B on a path toward the facility position of the visit facility B to the visit facility B may be set as a region B corresponding to the visit facility B. Furthermore, for example, when a break place C is set as a destination, the inside of the break place C may be set as a region C. As described above, the regions are preliminarily determined automatically or manually for customer places, points, or the like, and are preferably stored preliminarily in the vehicle information output device 10f or the storage 40.

Since pieces of processing of the data processor 15 and the output unit 16 are similar to those in the first embodiment, detailed descriptions thereof are omitted.

Next, a processing procedure of a monitoring device according to the above-described seventh embodiment will be described with reference to a flowchart of FIG. 14. FIG. 14 is a flowchart illustrating an example of a processing procedure of a vehicle information output method according to the seventh embodiment. Note that the same step numbers are attached to steps similar to the pieces of processing in the first embodiment, and detailed descriptions thereof are omitted.

After Step S11, in Step S71, the vehicle information acquisition unit 11a acquires position information on at least one of the current position of the vehicle, a destination, and a transit point from a GNSS or a navigation device. The vehicle information acquisition unit 11a outputs the acquired position information on the vehicle to the protection mode selector 14f, and proceeds to Step S72.

In Step S72, the protection mode selector 14f selects a protection mode including whether or not protection of data is necessary at least based on whether or not the acquired position information is within a predetermined region. For example, when the acquired position information is within the predetermined region, the protection mode selector 14f decides to protect data, and selects a mode of protecting data by using a protection key preliminarily determined to correspond to the region. The protection mode selector 14f outputs the selected data protection mode to the data processor 15, and proceeds to Step S14.

Since pieces of processing after Step S14 are similar to the pieces of processing in the first embodiment, detailed descriptions thereof are omitted.

As described above, according to the seventh embodiment, the vehicle information output device 10f can select a protection mode including whether or not protection of data is necessary at least based on the acquired vehicle information containing the position information on the vehicle, and output data protected in the selected mode.

The vehicle information output device 10f configured as described above can protect and output data in a protection mode preliminarily determined for each region when the position information on the vehicle is within the predetermined region. The vehicle information output device 10f can protect data in such a mode that a person other than a person determined for each region cannot easily browse travel information on the vehicle. The vehicle information output device 10f can enable an appropriate person to decode or access protected data, and prevent an inappropriate person from easily decoding or accessing the protected data by using different protection keys for protecting data for each current position of the vehicle or each region preliminarily determined as a destination.

### Eighth Embodiment

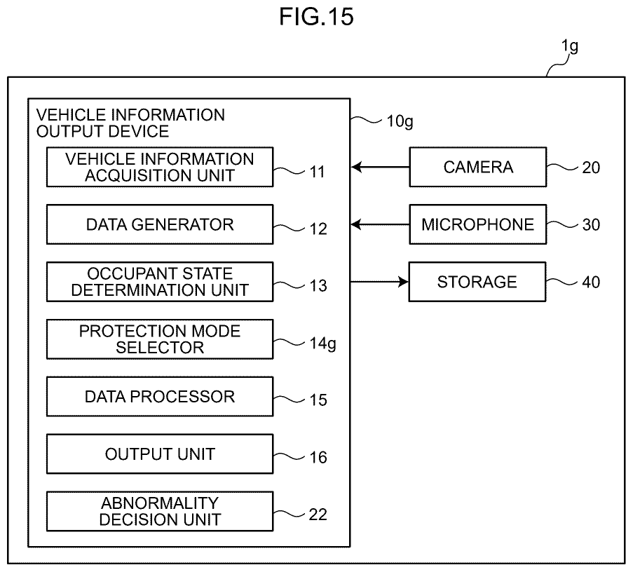

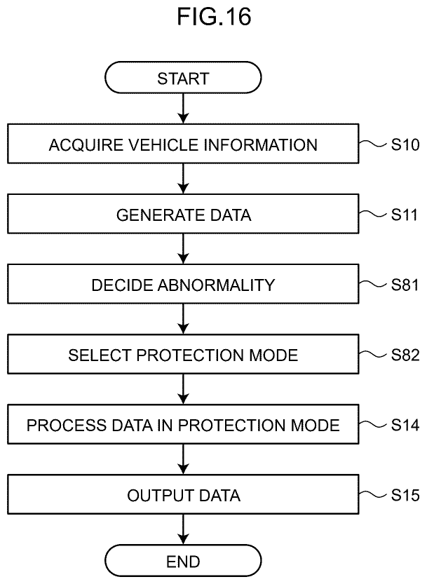

An eighth embodiment of the present disclosure will be described with reference to FIGS. 15 and 16. FIG. 15 is a block diagram illustrating an example of a configuration of a vehicle information output system 1g according to the eighth embodiment. The vehicle information output system 1g according to the eighth embodiment includes a vehicle information output device 10g. The vehicle information output device 10g has a configuration different from that of the vehicle information output device 10 according to the first embodiment in the following point.

That is, an abnormality decision unit 22 and a protection mode selector 14g are provided. Since the vehicle information output device 10g has a configuration and a function similar to those of the vehicle information output device 10 according to the first embodiment except that the vehicle information output device 10g includes the abnormality decision unit 22 and the protection mode selector 14g, detailed descriptions thereof are omitted.

In the eighth embodiment, information on an abnormality that has occurred in the vehicle is used as first information on the vehicle. The abnormality decision unit 22 decides the abnormality.

The vehicle information output device 10g according to the eighth embodiment of the present disclosure achieves both maintenance of vehicle information in a case where an abnormality occurs in the vehicle and protection of the privacy of the occupant of the vehicle. When some abnormality occurs in the vehicle, the vehicle information output device 10g can appropriately manage information on the vehicle by outputting the vehicle information in a mode in which an administrator of the vehicle or the business can easily browse the vehicle information. Furthermore, when no abnormality occurs in the vehicle, the vehicle information output device 10g can protect data recording travel information in the case in a protection mode in which the privacy of the occupant of the vehicle can be protected, for example.

The abnormality decision unit 22 decides an abnormality that has occurred in the vehicle from the vehicle information acquired by the vehicle information acquisition unit 11, and sets the information on the decided abnormality that has occurred in the vehicle as first information on travel of the vehicle. For example, when an acquired acceleration sensor value is equal to or more than a predetermined value, the abnormality decision unit 22 decides that an abnormality, such as an accident and a collision, has occurred. For example, the abnormality decision unit 22 may detect the approach of a suspicious person and occurrence of a fire from an acquired image, and decide an abnormality. In addition, the abnormality decision unit 22 may decide an abnormality that has occurred in the vehicle by using a known technique of deciding an abnormality, such as detection of collision sound or a scream, detection of smoke detection, and an engine trouble of the vehicle. The abnormality decision unit 22 may decide not only the presence or absence of an abnormality but, for example, the above-described type of the abnormality for the occurrence of the abnormality. The abnormality decision unit 22 outputs information on whether or not an abnormality has been decided to the protection mode selector 14g.

The protection mode selector 14g selects a protection mode including whether or not protection of data is necessary at least based on whether or not the abnormality decision unit 22 has decided an abnormality. When the abnormality decision unit 22 decides an abnormality, the protection mode selector 14g sets protection of data as unnecessary, or selects a data protection mode using a protection key known by an administrator of the vehicle or a plurality of people in order to achieve a mode in which the administrator of the vehicle or the plurality of people can easily decode or access the data. When the abnormality decision unit 22 does not decide an abnormality, the protection mode selector 14g selects a data protection mode using a protection key known by the occupant of the vehicle in order to prevent the administrator of the vehicle or the plurality of people from easily decoding or accessing the data. The protection key is preferably selected with reference to correspondence information on protection keys associated with the presence or absence of an abnormality of the vehicle. The protection key may be selected with reference to correspondence information on protection keys associated with the type of an abnormality of the vehicle. The protection mode selector 14g outputs the selected protection mode including whether or not protection of data is necessary to the data processor 15.

The protection mode selector 14g preferably sets a protection mode of information on travel of the vehicle in a case where the abnormality decision unit 22 has not decided an abnormality as a mode of protecting data, which has been selected in another embodiment of the present disclosure. In other words, the eighth embodiment is preferably implemented in combination with another embodiment of the present disclosure. For example, when the abnormality decision unit 22 does not decide an abnormality and the occupant state determination unit 13 decides a state in which the privacy of the occupant of the vehicle should be respected, the protection mode selector 14g decides that protection of data is necessary.

Since pieces of processing of the data processor 15 and the output unit 16 are similar to those in the first embodiment, detailed descriptions thereof are omitted.

Next, a processing procedure of a monitoring device according to the above-described eighth embodiment will be described with reference to a flowchart of FIG. 16. FIG. 16 is a flowchart illustrating an example of a processing procedure of a vehicle information output method according to the eighth embodiment. Note that the same step numbers are attached to steps similar to the pieces of processing in the first embodiment, and detailed descriptions thereof are omitted.

After Step S11, in Step S81, the abnormality decision unit 22 decides whether or not an abnormality has occurred in the vehicle from the vehicle information acquired by the vehicle information acquisition unit 11. The abnormality decision unit 22 outputs the decided result to the protection mode selector 14g, and proceeds to Step S82.

In Step S82, the protection mode selector 14g selects a protection mode including whether or not protection of data is necessary at least based on whether or not an abnormality has occurred in the vehicle. When an abnormality occurs in the vehicle, the protection mode selector 14g selects, for example, a mode in which protection of data is unnecessary. When an abnormality does not occur in the vehicle, the protection mode selector 14g decides that protection of data is necessary, and selects, for example, a protection mode of protecting data with a protection key for prioritizing the privacy of the occupant of the vehicle. The protection mode selector 14g outputs the selected data protection mode to the data processor 15, and proceeds to Step S14.

Since pieces of processing after Step S14 are similar to the pieces of processing in the first embodiment, detailed descriptions thereof are omitted.

As described above, according to the eighth embodiment, the vehicle information output device 10g can select a protection mode of data containing vehicle information based on whether an abnormality has occurred in the vehicle, and output data protected in the selected mode.

The vehicle information output device 10g configured as described above can achieve both output of travel information on travel of the vehicle in a mode in which the travel information can be appropriately managed and appropriate protection and output of information related to the privacy of the occupant of the vehicle in the selected protection mode when an abnormality occurs in the vehicle. When an abnormality occurs in the vehicle, the vehicle information output device 10g protects and outputs data serving as a record of the abnormality that has occurred in the vehicle in a protection mode in which an administrator of the vehicle, an administrator of business using the vehicle, and a person concerned in the abnormality can decode or access the data. When an abnormality does not occur in the vehicle, the vehicle information output device 10g protects and outputs data in, for example, a protection mode selected in another embodiment of the present disclosure. Using different protection keys for protecting data between a case where an abnormality has occurred in the vehicle and a case where an abnormality does not occur in the vehicle can enable an appropriate person to decode or access protected data, and prevent an inappropriate person from easily decoding or accessing the protected data.

### Other Embodiments

The specific examples and the like in the above-described first to eighth embodiments in the present disclosure are merely examples for facilitating understanding of the invention, and do not limit the present invention unless otherwise specified.

Note that the present disclosure is not limited to the first to eighth embodiments, and can be appropriately changed without departing from the gist thereof. Furthermore, the present invention may be implemented by appropriately combining the respective embodiments.

### Variation

In the specific examples in the first to eighth embodiments of the present disclosure, the embodiments are implemented in a vehicle, and a problem to be solved is to appropriately protect vehicle information. A variation is not limited to the form. The problem may be to appropriately protect information to be protected, which is information to be protected. For example, the “occupant of the vehicle” in the first to eighth embodiments may be replaced with a “person”. For example, the occupant state determination unit 13 according to the first embodiment may determine the state of a person in a specific region as a person state determination unit. Although, in the first to eighth embodiments, data to be protected is “vehicle information”, general “information”, for example, an image obtained by imaging a person and scenery, collected voice, position information, and other pieces of optionally acquired information may be protected. In the case, the vehicle information acquisition unit 11 may be an information-to-be-protected acquisition unit that acquires information to be protected. Similarly, the occupant authentication unit 17, the travel safety decision unit 18, and the occupant information acquisition unit 19 may be replaced with a person authentication unit, a safety decision unit, and a person information acquisition unit, respectively. The information to be protected is not limited to information on an occupant of a vehicle and safety on vehicle travel. The information to be protected may relate to a person and the safety of a predetermined region In a variation of the first embodiment, for example, a protection mode of protecting data containing an image obtained by imaging a predetermined region such as the inside of a room and the inside of premises can be a form selected based on the state of a person in the region.

As described above, in the variation, the vehicle information output device may be mounted as an information-to-be-protected output device applied also to information to be protected, which contains information other than vehicle information on a vehicle.

The information-to-be-protected output device includes: an information acquisition unit that acquires information to be protected; a data generator that generates data containing the information to be protected; a protection mode selector that selects a protection mode including whether or not protection of data is necessary based on first information; a data processor that processes the data in the protection mode; and an output unit that outputs the data that has been processed to a storage or an external device via a communicator.

In the first to eighth embodiments of the present disclosure, the data generator 12 may generate first information, for example, data separated at the timing when the state of the occupant of the vehicle changes. The occupant state determination unit 13 and the occupant state determination unit 13b have determined the state of the occupant of the vehicle. The data generator 12 may generate a plurality of data by acquiring information on the state of the occupant of the vehicle as first information from the occupant state determination unit 13 or the occupant state determination unit 13b, closing data generated in accordance with the timing when the state of the occupant of the vehicle changes, and opening new data. In the case, a single state of the occupant of the vehicle is associated with each piece of data.

The data generator 12 configured as described above clarifies the correspondence between each piece of data and the first information. In other words, each piece of data is associated with a single piece of first information. Preferably, this can facilitate selection of a protection mode of each piece of data, and reduce the probability of a mismatch between the protection mode of each piece of data and the first information.

Although, in the above-described embodiment, the present disclosure has been described as a configuration of hardware, the present invention is not limited thereto. In the present disclosure, any piece of processing can be performed by causing a processor to execute a computer program.

In the above-described example, programs are stored by various types of non-transitory computer-readable media, and can be supplied to the computer. The non-transitory computer-readable media include various types of tangible recording media, and include, for example, a magnetic recording medium such as a hard disk drive, an optical recording medium, a magnetooptical recording medium, and a semiconductor memory. The semiconductor memory can be various types of rewritable read only memories (ROMs) and random access memories (RAMs), and includes those provided as solid state drives (SSDs). Furthermore, the programs the programs may be supplied to the computer by various types of transitory computer-readable media via a wired communication path such as an electric wire and an optical fiber or a wireless communication path, and include, for example, electric signals, optical signals, and electromagnetic waves.

An execution order of each piece of processing in a device and a method described in the claims, the specification, and the drawings can be achieved in any order. Even if an operation flow in the claims, the specification, and the drawings is described by using “first”, “next”, or the like for convenience, it does not mean that execution in the order is essential.

According to the present disclosure, there can be provided a vehicle information output device, an information-to-be-protected output device, and a vehicle information output method capable of achieving both appropriate protection of the privacy of an occupant of a vehicle and appropriate management of travel information on travel of the vehicle by selecting a data protection mode for recording travel information on the vehicle based on first information on the vehicle.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle information output device comprising:
a vehicle information acquisition unit that acquires vehicle information on a vehicle;
a data generator that generates data containing the vehicle information;
a protection mode selector that selects a protection mode including whether or not protection of the data is necessary based on first information on the vehicle, including at least whether or not the vehicle is stopped;
a data processor that processes the data in the protection mode; and
an output unit that outputs the data that has been processed to a storage or an external device via a communicator.

2. The vehicle information output device according to claim 1, further comprising
an occupant state determination unit that determines whether an occupant of the vehicle is in a state not related to travel of the vehicle, based at least on information on the travel state of the vehicle acquired by the vehicle information acquisition unit,
wherein the first information further includes information indicating whether an occupant of the vehicle is in a state not related to travel of the vehicle.

3. The vehicle information output device according to claim 1, wherein
the vehicle is a business-purpose vehicle,
further comprising
an occupant state determination unit that determines whether the occupant of the vehicle is engaged in work,
wherein the first information further includes information indicating whether an occupant of the vehicle is in a state not related to travel of the vehicle.

4. The vehicle information output device according to claim 1, further comprising
an occupant state determination unit that determines a state of an occupant of the vehicle, and
a travel safety decision unit that decides safety of travel of a vehicle based on the vehicle information and the state of the occupant of the vehicle,
wherein, when the safety of the travel is lower than a predetermined reference level, the protection mode selector sets protection of the data as unnecessary, or selects a data protection mode using a protection key based on a person different from the occupant of the vehicle.

5. The vehicle information output device according to claim 1,
wherein the first information further includes information indicating whether at least a part that can be opened and closed on an exterior of the vehicle is open when the vehicle is stopped.

6. The vehicle information output device according to claim 1 further comprising
an occupant information acquisition unit that acquires information on relation between a driver and a passenger of the vehicle by using the passenger of the vehicle is associated with the relation between the driver and the passenger of the vehicle,
wherein the first information further includes relates to the relation between the driver and the passenger, and
the protection mode selector determines, based on the first information, whether to omit protection of the data or to protect the data using a protection key predetermined for each relation.

7. The vehicle information output device according to claim 1 further comprising
a condition acquisition unit that acquires a first condition designated by an occupant of the vehicle and a second condition set by an administrator of the vehicle,
wherein the first information further includes the second condition when the first condition is satisfied

8. The vehicle information output device according to claim 1,
wherein the first information further includes information whether a current position or destination of the vehicle, which is contained in the vehicle information is within a predetermined area,
the protection mode selector that selects a protection key defined for each area when the current position or destination of the vehicle is within the predetermined area, and
the data processor that protects the data using the selected protection key.

9. The vehicle information output device according to claim 1, wherein
the protection mode selector that, based on the first information, selects an encryption strength level for protecting the data or sets limiting conditions that restrict the selection of protection keys for protecting the data.

10. The vehicle information output device according to claim 1,
wherein the data generator generates data, which is separated at timing when the first information changes and with which the first information is associated, and
the protection mode selector selects, for each piece of data, a protection mode including whether or not protection of the data is necessary.

11. An information-to-be-protected output device comprising:
an information acquisition unit that acquires information to be protected regarding a person or a predetermined area where the person exists;
a data generator that generates data containing the information to be protected;
a person state determination unit that determines the state of the person, including the degree to which the privacy of the person should be prioritized;
a protection mode selector that selects a protection mode including whether or not protection of the data is necessary, and, if protection is deemed necessary, selecting a protection key to protect the data, based on the degree to which the privacy of the person should be prioritized, as determined by the person status determination unit;
a data processor that processes the data in the protection mode; and
an output unit that outputs the data that has been processed to a storage or an external device via a communicator.

12. A vehicle information output method comprising:
executing, by a computer:
a vehicle information acquisition step of acquiring vehicle information on a vehicle;
a data generation step of generating data containing the vehicle information;
a protection mode selection step of selecting a data protection mode based on first information on the vehicle, including at least whether or not the vehicle is stopped;
a data protection step of protecting the data in the protection mode; and
an output step of outputting the data that has been protected to a storage or an external device via a communicator.
